(19) United States
(12) Patent Application Publication
(10) Pub. No.: US 2026/0026513 A1
(43) Pub. Date: Jan. 29, 2026

(54) STABLE LIQUID SOURDOUGH

(71) Applicant: Mauri Technology B.V., Etten-Leur (NL)

(72) Inventors: Rozália Borbála KENDERESI, Etten-Leur (NL); David Bernard Edmond LANSARD, Etten-Leur (NL)

(73) Assignee: Mauri Technology B.V., Etten-Leur (NL)

(21) Appl. No.: 19/475,547

(22) PCT Filed: Apr. 18, 2024
(86) PCT No.: PCT/NL2024/050199

§ 371 Date: Oct. 15, 2025

(30) Foreign Application Priority Data
Apr. 18, 2023 (EP) 23168534.8

(51) Int. Cl. A21D 8/04; A21D 2/18; A21D 2/38

(52) U.S. Cl. CPC A21D 8/045; A21D 2/181; A21D 2/38; A21D 8/047; A23V 2400/121; A23V 2400/169

(57) ABSTRACT

The invention relates to a leavening mixture comprising: cereal flour, preferably wheat flour, active malt flour, at least one inactive yeast, at least one active lactic acid producing starter bacterium, at least one active starter yeast and water. The invention further relates to a method for preparing liquid sourdough, comprising i) preparing a dough comprising cereal flour, active malt flour, at least one inactive yeast, at least one active lactic acid producing starter bacterium, at least one active starter yeast and water to obtain the dough ii) subjecting the dough to fermentation, thereby forming a liquid sourdough; iii) cooling the fermented mixture to a temperature of less than 10° C.

### FIELD

The invention relates to a leavening mixture, such as a liquid sourdough. The invention further relates to a method for preparing a sourdough and to a method for preparing a sourdough bread.

### INTRODUCTION

Keeping a natural and traditional leaven is a high maintenance process for the baker. It is necessary to carry out daily refreshments to maintain the quality of the sourdough. Changes in the substrate or the surroundings can lead to changes in the sourdough properties. Changes in the sourdough properties will naturally lead to changes in the finished baked product. In best case scenario these are flavour based and subtle, but often the sourdough changes in such a way as to negatively affect the dough handling and physical properties of the finished product, or it can lead to strong off-flavours in the sourdough.

Increasingly, around the world, legislation surrounding leaven (sourdough) is moving towards the French model, whereby bread labelled as “sourdough bread” must be made with an active leaven, with only minimal (0.2-0.5%) yeast addition permitted at the baking phase.

Therefore, a challenge in the field is to create a liquid sourdough that is clean label, of consistent quality and able to provide sufficient leavening ability (i.e. gassing power) throughout minimum three months of shelf life. Such a product can be used by a baker at any point in the shelf life to create baked goods of good consumer acceptance and the typical properties of taste, texture and colour associated with sourdough bakery products. Such product ideally must also be consistent in quality from batch to batch, always producing the same results when applied in the same recipes and methods by the baker.

A ready-to-use liquid baker's leaven is described in EP0953288B1, WO2017060165A1 and WO2017060230A1.

A disadvantage of these known leavening mixtures is that they are sensitive to changes in substrate and surroundings, leading to changes in sourdough properties. These changes in sourdough properties can result in changes in flavour, which are often disadvantageous. A further disadvantage of the known leavening mixtures is that they have relatively short shelf lives.

There is a need for alternative leavening mixtures, in particular a leavening mixture addressing one or more of the disadvantages in the prior art such as described above. It is an object of the invention to provide such leavening mixture. It is in particular an object to provide a leavening mixture that is ready-to-use, more in particular such mixture that has at least one of the following advantages: no need for refreshment, a reduced batch-to-batch deviation in quality (more consistent batch to batch quality), a more consistent quality over the shelf-life and an increased shelf-life.

### BRIEF DESCRIPTION OF THE INVENTION

It was surprisingly found that including an inactivated yeast in a (sourdough) leavening mixture, overcomes one or more of the abovementioned disadvantages. More specifically, as illustrated in the Examples, using a leavening mixture according to the invention a shelf life of over 16 weeks was reached.

Further, the inclusion of Lachancea thermotolerans as an active starter yeast in a leavening mixture (further comprising usual leavening mixture ingredients) resulted in improved properties, such as one or more improvements selected from: an increased number of colony forming units (CFU), a more stable pH, a more stable total titratable acidity (TTA), reduced batch-to-batch deviation, better baking performances and improved gassing power compared to leavening mixtures comprising other yeast strains as active starter yeasts.

Accordingly, the invention relates to a leavening mixture, such as a liquid sourdough, comprising: cereal flour, preferably wheat flour; active malt flour; at least one inactive yeast; at least one active lactic acid producing starter bacterium; at least one active starter yeast; and water.

Further, the invention relates to a method for preparing a liquid leavening mixture, such as a liquid sourdough, comprising:
i) preparing a dough comprising cereal flour (preferably wheat flour), active malt flour, at least one inactive yeast, at least one active lactic acid producing starter bacterium, at least one active starter yeast and water to obtain the dough;
ii) subjecting the dough to fermentation, thereby forming a liquid sourdough;
iii) cooling the fermented mixture to a temperature of less than 10° C., preferably within 2 hours after having subjected the dough to fermentation.

Further, the invention relates to a method for preparing a sourdough-leavened bread, comprising the steps of:
i) providing a liquid sourdough of the invention;
ii) making a bread dough comprising the liquid sourdough and further bread ingredients;
iii) allowing the bread dough to leaven; and
ii) baking the bread dough, thereby forming the bread.

Further, the invention relates to a sourdough-leavened bread, obtained by said method for preparing a sourdough-leavened bread.

### BRIEF DESCRIPTION OF THE FIGURES

FIG. 1. CFU/g of lactic acid bacteria (LAB) and yeast in a sourdough obtained by using a sourdough formulation without inactive yeasts (A) and a sourdough obtained by using a leavening mixture with inactive yeasts (B) over the shelf life of the obtained sourdough (expressed in weeks).

FIG. 2. Total titratable acidity (TTA) and pH in a sourdough obtained by using a leavening mixture without inactive yeasts (A) and a sourdough obtained by using a leavening mixture with inactive yeasts (B) over the shelf life of the sourdough (expressed in weeks).

FIG. 3. Acid content (i.e. lactic acid and acetic acid content) (in ppm) of a sourdough obtained by using a leavening mixture without inactive yeasts (A) and a sourdough obtained by using a leavening mixture with inactive yeasts (B) over the shelf life of the obtained sourdough (expressed in weeks).

FIG. 4. CFU/g of LAB and yeast in sourdough obtained by using a leavening mixture with malt flour (indicated by hatched bars) and without malt flour (indicated by solid bars) over a 10 week period.

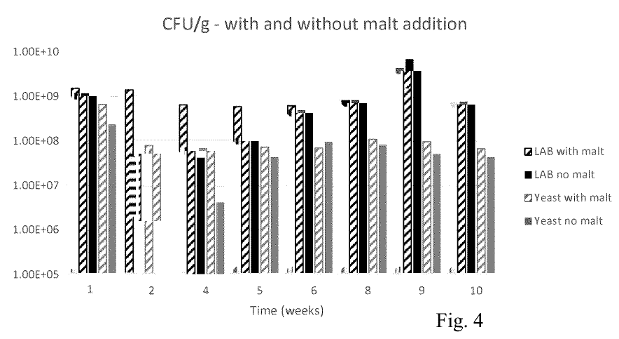

### DETAILED DESCRIPTION OF THE INVENTION

### Definitions

As are used herein, the singular forms “a”, “an” and “the”, are intended to include the plural forms as well.

As is used herein, the term “or” includes any and all combinations of one or more of the associated listed items, unless the context clearly indicates otherwise (e.g. if an “either . . . or” construction is used).

As are used herein, the terms “comprise” and “comprising”, and conjugations thereof, are open language and specify the presence of stated features but do not preclude the presence or addition of one or more other features.

Any text or reference signs placed between parentheses shall not be construed as limiting, unless the context clearly indicates otherwise.

It will be understood that when a particular step of a method is referred to as subsequent to another step, it can directly follow said other step or one or more intermediate steps may be carried out before carrying out the particular step, unless specified otherwise.

As is used herein, the term “wt %”, or “weight percentage”, or “percentage by weight”, generally refers to the mass fraction of a substance in a composition divided by the total mass of said composition, expressed as a percentage in the range of 0 to 100, unless specified otherwise.

The term “(at least) substantial(ly)” is generally used herein to indicate that it has the general character or function of that which is specified. When referring to a quantifiable feature, this term is in particular used to indicate that it is at least 50%, more in particular more than 75%, even more in particular more than 90% of the maximum of that feature.

The term “(at least) essential(ly)” is generally used herein to indicate that it has the general character or function of that which is specified. When referring to a quantifiable feature, it generally includes a deviation of 15% or less from the given value, in particular a deviation of 10% or less, more in particular a deviation of 5% or less.

As is used herein, the term “about” in relation to a value generally includes a range around that value as will be understood by the skilled person. In particular, the range is from at least 10% below to at least 10% above the value, more specifically from 5% below to 5% above the value.

As is used herein, the term “leavening agent”, refers to an ingredient that (in use) increases the volume and/or lightens the texture of a dough respectively a baked product. When mixed with a liquid, the leavening agent can form carbon dioxide gas bubbles, which cause a batter or dough to rise during (and sometimes before) the baking process. Examples of leavening agents include microbiological leavening agents, in particular (food-grade) CO₂-producing yeasts, like Saccharomyceseae; (food-grade) CO₂-producing bacteria, like Lactobacilluseae. Further examples of leavening agents include chemical leavening agents, such as baking powder; baking soda; ammonium bicarbonate; potassium bicarbonate; potassium bitartrate; potassium carbonate; and monocalcium phosphate.

A leavening mixture is a mixture comprising a leavening agent, such mixture intended for leavening a dough, or intended a starting material for preparing a sourdough.

As is used herein, the term “dough”, refers to a mixture comprising flour (typically as a most abundant component based on weight) and water (in a sufficient amount to at least substantially hydrate the flour, and—if present—bran), which can be kneadable (i.e. without necessarily be free flowing under the influence of gravity) or can be liquid (i.e. free flowing under the influence of gravity).

As is used herein, the term “sourdough”, refers to a fermented dough (also known as brew, for a liquid sourdough) fermented by lactic acid bacteria (LAB) and yeast, having a characteristic acidic flavour due to the lactic acid bacteria producing mainly lactic acid, acetic acid and some minor compounds and the typical flavour top-notes produced by the yeast. The presence of a microbiological leavening agent in the sourdough provides leavening of the dough. A sourdough comprises at least flour, typically cereal flour, such as wheat and/or rye flour; water; and an active microorganism, such as a LAB and/or yeast. A sourdough may additionally comprise one or more (conventionally used) ingredients, e.g. salt. A sourdough comprises a leavening agent intended for leavening a dough and as such is a “leavening mixture” per definition.

As is used herein, the term “active” for a microorganism, such as a bacterium or yeast, refers to a microorganism being capable of reproduction, metabolizing or colonization.

As is used herein, the term “inactive” for a microorganism, such as a bacterium or yeast, refers to a microorganism not being capable of reproduction, metabolizing or colonization.

As is used herein, the term “lactic acid producing bacterium”, refers to a general term for a bacterium that can produce lactic acid, at least when living. The term refers not only to lactic acid-producing bacteria belonging to the order Lactobacillus including genera such as Lactobacillus, Lactiplantibacillus, Weissella and Pediococcus, but includes other lactic acid producing bacteria, including Bifidobacterium belonging to the order Bifidobacteriales. Commonly used LAB in sourdoughs are L. brevis, L. buchneri, W. cibaria, L. fermentum, L. reuteri, L. sanfranciscensis, L. kefir, L. plantarum, L. pentosus, L. alimentarius, L. casei, L. paracasei, L. rhamnosus, P. acidilactici, P. pentosaceus, L. amylovorus, L. acidophilus, L. amylolyticus, L. delbreuckii and P. damnosus.

As is used herein, the term “starter” for an microorganism, refers to a microorganism, such as a yeast or bacterium, able to assist the beginning of a fermentation process in preparation of a dough, such as sourdough. General requirements for a microorganism to be suitable as a starter, include the ability to survive, metabolise and grow in a substrate, in this invention a substrate comprising flour and water, the absence of production of substances harmful to human health such as biogenic amines and toxins; the absence of resistance to antibiotics. A person skilled in the art may consult the “qualified presumption of safety (QPS)” requirements of the European Food Safety Authority (EFSA) as a guide for safety requirements of suitable starting microorganisms. A further requirements for a LAB to be suitable as a starter is the ability to produce organic acids (lactic and acetic primarily) and aroma compounds. A further requirements for a yeast to be suitable as a starter is the ability to produce carbon dioxide and thus ability to provide leavening power to the sourdough.

As is used herein, the term “pH” refers to the apparent pH, i.e. the pH measured using a standard H+ electrode, at 20° C. The pH is measured by inserting a calibrated pH electrode in a medium, such as an aqueous fluid of which the pH is to be measured. For non-fluid media, such as bread, doughs and leavening mixtures in general (including liquid sourdoughs), a suitable amount of the medium is typically suspended in distilled water (typically 5 g or 10 g per 100 ml distilled water). As used herein, the pH of a leavening mixture, e.g. liquid sourdough, is the pH as measured by inserting a calibrated pH electrode in an aqueous suspension of 5 g of leavening mixture suspended in 100 ml of distilled water. The pH of a sourdough bread, as used herein, is the pH as measured by inserting a calibrated pH electrode in an aqueous suspension of 10 g of sourdough bread crumb suspended in 100 ml of distilled water.

As is used herein, the term “Total Titratable acidity (TTA)” refers to the amount (in ml) of a 0.1 M NaOH solution that is titrated until a pH of 8.5 is reached. The TTA of a leavening mixture can be measured by determining the amount of a 0.1 M NaOH solution that is added to an aqueous suspension of 5 g of leavening mixture suspended in 100 ml of distilled water until a pH of 8.5 is reached. The TTA of a sourdough bread can be measured by determining the amount of a 0.1 M NaOH solution that is added to an aqueous suspension of 10 g of crumb suspended in 100 ml of distilled water until a pH of 8.5 is reached. TTA is calculated by dividing 10 by the sample weight (g), and multiplying the obtained value by the NaOH content (ml).

### Ingredients

A leavening mixture according to the invention comprises cereal flour, (active) malt flour, at least one inactive yeast, at least one active lactic acid producing starter bacterium, at least one active starter yeast and water. Preferably, it further comprises a cereal bran, such as wheat bran.

The cereal flour, preferably is wheat flour. Further, rye flour is particularly suitable, which may be part of a mixture of wheat flour and rye flour. Cereal flour is a powder derived from the milling, grinding and sifting of a cereal grain. It is a substrate for fermentation.

Cereal bran is the remainder of cereal grains from which the endosperm portion has been removed, or the residue from which the attached endosperm or germ has been further removed in the process of producing cereal flour, such as wheat flour. Cereal bran typically essentially consists of the hard outer layers of the grain. The hard outer layers are typically at least substantially composed of the aleurone, the pericarp and (if present) the pedicel. The bran increases buffering capacity for a higher end total titratable acidity (TTA) of the sourdough.

The at least one active lactic acid producing starter bacterium may be selected from the group consisting of L. brevis, L. buchneri, W. cibaria, L. fermentum, L. reuteri, L. sanfranciscensis, L. kefir, L. plantarum, L. pentosus, L. alimentarius, L. casei, L. paracasei, L. rhamnosus, P. acidilactici, P. pentosaceus, L. amylovorus, L. acidophilus, L. amylolyticus, L. delbreuckii and P. damnosus. Preferably, the at least one active lactic acid producing starter bacterium is selected from L. brevis and L. plantarum. Lactic acid producing bacteria contribute to the acid and aroma production.

The at least one active starter yeast may be selected from yeasts of the order Saccharomyces, in particular from Lachancea, Kazachstania, Wickerhanomyces, Torulaspora, Pichia, Candida and Saccharomyces, more in particular from the group consisting of Lachancea thermotolerans, Kazachstania humilis, Wickerhanomyces anomalus, Torulaspora delbreuckii, Pichia kudriavzevii, Candida glabrata and Saccharomyces cerevisiae. Preferably, the at least one active starter yeast is Lachancea thermotolerans. The starter yeast in a leavening mixture according to the invention contributes to ability to provide gassing. Furthermore, Lachancea thermotolerans in a leavening mixture according to the invention may contribute to the acid production.

Inactive yeast can be included in a leavening mixture in accordance with the invention in the form of a powder, resulting in a relaxing effect on the dough through interactions with the gluten network (Meerts et al., 2018. Journal of Cereal Science 82:183-189). In accordance with the invention it can also be added as a liquid. Typically, it is added before fermentation is started or in the initial stage of fermentation. In liquid sourdough production, this “relaxing” effect has the benefit of allowing better mixing of the substrate—when the flour and water is mixed for too long before adding starters, the act of mixing can cause strands of gluten to form, which negatively effects the consistency of the product. It was found by the inventors that the use of inactive yeast in a liquid leavening mixture according to the invention is for the benefit of the micro-organisms used for the preparation of the sourdough, and to increase the total acids present in the sourdough without causing a decrease in the pH to levels that are toxic to the microbes. The increase in acidity is important, when the leavening mixture according to the invention aims to be able to fulfil certain criteria (see also below), namely when aiming to prepare a bread obtained with said (sourdough) leavening mixture having a relatively low pH, namely a maximum pH of 4.3 (measured in the crumb) and/or an acetic acid concentration of at least 900 ppm). The inactive yeasts have an effect on the buffering capacity of the sourdough. Buffering capacity is the amount of acid or base that can be added to a volume of solution before its pH changes significantly. Inactive yeasts are also known to be good sources of nutrients such as proteins, peptides, amino acids, polysaccharides, vitamins, and minerals; to be containing about 45-55% of protein and to be rich in glutamic acid (Pozo-Bayón et al., 2009. Food Research International 42:754-761; Toh and Liu, 2017. AMB Express 7:156-156).

Malt flour is a dried powdered product usually made from germinated cereal. Barley is the most commonly malted grain, in part due to its high diastatic power or enzymatic content. The term “active malt flour”, refers to a malt flour that comprises an enzyme having amylase activity, such as alpha-amylase activity and/or beta-amylase activity. Active malt flour breaks starches in flour down to smaller sugars. These smaller sugars are more bioavailable to the LAB and active yeast added to the sourdough, which leads to a more efficient fermentation of the substrate. It was found that less residual sugars were left in the sourdough after processing was finished when using a leavening mixture comprising malt flour, resulting in a product with a more stable shelf life compared to a sourdough without malt flour. Without being bound by theory, with less residual sugars for the LAB and yeast to ferment, the LAB and yeast aren't converting the sugar into more harmful substances (i.e. harmful for the bacteria and yeasts) like acids and carbon dioxide, leading to more stability over shelf life in the product. Usually, the active malt flour is selected from the group consisting of active barley malt flour, active wheat malt flour, active rye malt flour, active corn malt flour and active rice malt flour Preferably, the active malt flour is a malted wheat flour.

Additional active yeast, in particular S. cerevisiae, may advantageously be added at or near the end of the fermentation or thereafter, to provide additional gassing power during the shelf life of the sourdough.

### Methods to Determine Stability of a Sourdough Over Shelf Life

Stability over shelf life is a very important property of liquid sourdough formulations. The end user (mostly a baker) can receive and use a product at any point over its shelf like, which usually should be at least 12 weeks, in particular 12-16 week, and the product should perform essentially the same regardless of the point in time it is used (within reason). This means that the acidity should not change dramatically, and the LAB and active yeast need to have a sufficient viability throughout shelf life-particularly the yeast as they provide the leavening power of the sourdough.

Cell counts of lactic acid bacteria (LAB) and yeast cell counts can be determined using methods known to a skilled person such as for example by plating serial dilution of sourdough samples on an agar plate such as a Man Rogosa Sharpe (MRS) plate with cycloheximide and a Yeast extract Peptone Dextrose (YPD) agar plate with chloramphenicol for the determination of LAB and yeast cell counts respectively.

Organic acids and sugars may be quantified by performing high performance liquid chromatography (HPLC). For example, a suspension of 2 g of leavening mixture in 20 mL of Milli-Q water may be prepared, shaken and thereafter centrifuged at 4000 rpm for 15 min. Hereafter, the supernatants may be filtered directly in a HPLC vial for quantification by HPLC e.g. by using an Agilent Hi-Plex H (4.7×300 mm) HPLC column according to the manufacturer's instructions. To quantify organic acids in sourdough bread, 0.20 g of bread crumb may be mixed with 100 ml of water, homogenized and centrifuged at 5000 rpm for 15 min. Hereafter, the supernatants may be filtered directly in a HPLC vial for quantification by HPLC e.g. by using an Agilent Hi-Plex H (4.7×300 mm) HPLC column according to the manufacturer's instructions. Organic acids can be detected with a variable wavelength detector (VWD) at 210 nm and sugars can be detected with a refractive index (RID) detector. The organic acid content, e.g. acetic acid and lactic acid content, can be expressed in mg/kg or ppm, which are equivalent. A sensory characterization of a sourdough bread may be obtained by a quantitative descriptive analysis method by which a bread is described in terms of its attributes and the intensity of these attributes, for example as follows. Sourdough bread slices, e.g. 1.4 cm thickness, are evaluated by a panel, typically consisting of at least about 10, e.g. 13 trained panelists. The slices are evaluated in individual sensory booths free of odours, noise, or any other distraction. During a formal sensory evaluation, each panelists receives coded slices in monadic sequence and in randomize order. Using a computerized data collection system, panelists score the perceived intensity of each sensory attributes on a continuous line scale of 15 cm (6 inch), anchored 2.5 cm (0.5 inch) from either end. In between samples, panelists are asked to take a mandatory pause of one minute to neutralize their palate by rinsing their mouth with water and eating an unsalted cracker. All samples are presented at room temperature and are evaluated in duplicate.

In an embodiment, the leavening mixture is an intermediate product for preparing a liquid sourdough according to the invention. Such leavening mixture is typically a dough, which has an initial pH (at 20° C.) above 4.5, preferably in the range of 5.5-7.0, more preferably in the range of 5.8-6.5, e.g. about 6.0.

A leavening mixture, in particular a sourdough according to the invention preferably comprises between 10⁷ and 10¹¹ CFU of LAB per gram, more between 10⁸ and 10¹⁰ CFU of LAB per gram, more preferably about 10⁹ CFU of LAB per gram and between 10⁵ and 10⁹ CFU of yeast per gram, preferably between 10⁶ and 10⁸ of yeast per gram, more preferably about 10⁷ of yeast per gram.

The leavening mixture, in particular the liquid sourdough according to the invention preferably has a pH in the range of 3.5 to 4.6, more preferably has a pH in the range of 3.9 to 4.2.

The liquid sourdough according to the invention usually has a viscosity at 25° C. of less than 10 000 mPa·s (cP). The viscosity of the liquid sourdough at 25° C. usually is at least 100 mPa·s (at least directly after preparation). The viscosity of the liquid sourdough at 25° C. is preferably in the range of about 2000 to about 9000 mPa·s, more preferably in the range of about 4000 to about 8000 mPa·s. A relatively low viscosity is advantageous with respect to pumpability (during processing) and dosing (by the end-user). As used herein the viscosity is the apparent viscosity as measured by a rotational viscosimeter applying ASTM/ISO 2555 standard (as applicable on 13 Apr. 2024). This kind of viscosimeter is generally known in the art. For instance a LamyRheology Instruments Black One viscosimeter may be used in accordance with its user instructions. In particular, the following spindle number is used, dependent on the maximum viscosity (Pa·s) value according to speed and ASTM/ISO2555 spindle:

| Speed | Spindle number | | | | | | |
|---|---|---|---|---|---|---|---|
| rpm | Astm1* | Astm2 | Astm3 | Astm4 | Astm5 | Astm6 | Astm7 |
| 250 | 0.56 | 2.22 | 5.56 | 11.12 | 22.26 | 55.65 | 222.6 |
| 200 | 0.69 | 2.78 | 6.95 | 13.91 | 27.82 | 69.55 | 278.2 |
| 100 | 1.39 | 5.56 | 13.91 | 27.82 | 55.65 | 139.1 | 556.5 |
| 60 | 2.31 | 9.27 | 23.18 | 46.36 | 92.75 | 231.8 | 927.5 |
| 50 | 2.78 | 11.13 | 27.82 | 55.65 | 111.3 | 278.2 | 1113 |
| 40 | 3.47 | 13.91 | 34.77 | 69.54 | 139.1 | 347.7 | 1391 |
| 30 | 4.63 | 18.55 | 46.36 | 92.72 | 185.5 | 463.6 | 1855 |
| 20 | 6.95 | 27.82 | 69.55 | 139.1 | 278.2 | 695.5 | 2782 |
| 12 | 11.59 | 46.37 | 115.9 | 231.8 | 493.7 | 1159 | 4937 |
| 10 | 13.91 | 55.65 | 139.1 | 278.2 | 556.5 | 1391 | 5565 |
| 6 | 23.18 | 92.75 | 231.8 | 463.6 | 927.5 | 2318 | 9275 |
| 5 | 27.82 | 111.3 | 278.2 | 556.5 | 1113 | 2782 | 11130 |
| 4 | 34.77 | 139.1 | 347.7 | 695.5 | 1391 | 3477 | 13910 |
| 3 | 46.36 | 185.5 | 463.6 | 927.2 | 1855 | 4636 | 18550 |
| 2.5 | 55.64 | 222.6 | 556.5 | 1112.8 | 2226 | 5565 | 22260 |
| 2 | 69.55 | 278.2 | 695.5 | 1391 | 2782 | 6955 | 27820 |
| 1.5 | 92.73 | 371 | 927.3 | 1854 | 3710 | 9273 | 37100 |
| 1 | 139.1 | 556.5 | 1391 | 2782 | 5565 | 13910 | 55650 |
| 0.6 | 231.8 | 927.5 | 2318 | 4636 | 9275 | 23180 | 92750 |
| 0.5 | 278.2 | 1113 | 2782 | 5565 | 11130 | 76800 | 111300 |
| 0.3 | 463.6 | 1855 | 4636 | 9272 | 18550 | 128000 | 185500 |

A relatively high viscosity generally is the result of a relatively low water content, and thus a relatively high content of active ingredients. Thus, a relatively high viscosity is advantageous in that the liquid sourdough is more concentrated and requires less volume per amount of bakery product that can be made with it.

The liquid sourdough according to the invention preferably has a TTA in the range of 13 to 28, more preferably has a TTA in the range of 16 to 25.

The liquid sourdough according to the invention preferably has a acetic acid content in the range of 900 to 3200 mg per kilogram of the liquid sourdough, preferably from 1600 to 2800 mg per kilogram of the liquid sourdough, more preferably from 1800 to 2600 mg per kilogram of the liquid sourdough.

The liquid sourdough according to the invention preferably has a lactic acid content ranging from 6000 to 20000 mg per kilogram of the liquid sourdough, preferably from 8000 to 18000 mg per kilogram of the liquid sourdough, more preferably from 9500 to 16000 mg per kilogram of the liquid sourdough.

A sourdough-leavened bread according to the invention preferably has a pH of maximum 4.3 and acetic acid concentration of at least 900 ppm (equivalent to 900 mg/kg).

Additionally, a sourdough-leavened bread according to the invention may comprise between 0.05% and 0.35%, preferably between 0.1% and 0.3%, more preferably between 0.15% and 0.25%, such as about 0.2%, of Saccharomyces cerevisiae relative to the weight of flour in the sourdough.

In order to prepare a leavening mixture, such as a liquid sourdough, according to the invention a mixture of water and flour, inactive yeast, active malt flour, LAB and yeast starters, and preferably a cereal bran, in particular wheat bran, is provided. This mixture can e.g. be made by mixing the water and other ingredients in a manner known per se. Advantageously, essentially all of the flour, inactive yeast, malt, LAB and yeast starters (and bran, if used) are added integrally to form a fermentable dough, which is integrally subjected to fermentation (rather than e.g. providing a first part of the ingredients that is fermented in the presence of the LAB starter and a second part of the ingredients that is fermented in the presence of the yeast starter). A surprisingly good liquid sourdough is thus obtainable with a simplified method.

The water content of the leavening mixture according to the invention, such as the liquid sourdough is usually in the range of about 40 to about 75 wt. %, in particular about 40 to about 70 wt. %. A relatively high water content results in a relatively low viscosity, which facilitates pumping during processing and dosing (e.g. by pouring) when preparing a dough that is to be baked to yield and end-product such as a sourdough leavened bread. A relatively low water content is advantageous for the production of a concentrated leavening mixture. In a first advantageous embodiment, the water content of the dough to be subjected to fermentation is in the range of about 60 to about 75 wt. %, more preferably in the range of 60-70 wt. %. In a second advantageous embodiment, the water content of the dough to be subjected to fermentation is in the range of about 40 to about 60 wt. %, in particular in the range of 45 wt. % to 55 wt. %, more in particular in the range of 49 wt % and 51 wt. %, e.g. about 50 wt. %.

Usually, the cereal flour content of the dough to be subjected to fermentation (fed to the fermenter) is at least about 20 wt. %, preferably at least 22 wt. %, more preferably at least 24 wt. %, in particular at least 27 wt. %. Usually, the cereal flour content of the dough to be subjected to fermentation (fed to the fermenter) is about 45 wt % or less.

In a first advantageous embodiment (wherein the water content is in the range of about 60 to about 75 wt. %, in particular in a range of about 60 to about 70 wt. %), the cereal flour content of the dough to be subjected to fermentation is about 20 wt. % to about 37 wt. %, preferably about 22 wt. % to about 35 wt. %, in particular about 23 wt. % to about 30 wt. % or 24 wt. % to 29 wt. %. In a second advantageous embodiment (wherein the water content is in a range of about 40 to about 60 wt. %), the cereal flour content in a leavening mixture according to the invention is between 37 wt % and 45 wt %, more preferably between 39 wt % and 43 wt %, more preferably between 40.2% and 41.8 wt %, such as about 41 wt % of the leavening mixture.

The cereal flour preferably comprises 50-100 wt. % of wheat flour, more preferably at least 60 wt. % of wheat flour, more preferably at least 70 wt. % of wheat flour, more preferably at least 80% of wheat flour, most preferably at least 90% of wheat flour. The cereal flour may comprise rye flour such as for example 10-100 wt %, at least 20 wt. %, at least 30 wt. %, at least 40 wt. %, at least 50 wt. %, at least 60 wt. %, at least 70 wt. %, at least 80 wt. %, at least 90 wt. % of rye flour. Usually, in particular when used in combination with wheat flour, the rye flour content is up to 50%, up to 40%, up to 30 wt. %, up to 20 wt. % or up to 10 wt. %.

In a preferred embodiment, the leavening mixture comprises cereal bran, in particular wheat bran. The bran can serve as a further substrate for a micro-organism in the leavening mixture. The cereal bran content, preferably the wheat bran content, in a leavening mixture according to the invention usually is in the range of 0 to 3 wt. %. Preferably, the cereal bran content, in a leavening mixture according to the invention is up to 2.5 wt. %, more preferably up to 2.25 wt. %, such as about 2 wt. %. If present, the cereal bran content, in particular the wheat bran content, in a leavening mixture according to the invention usually is at least 0.5 wt. %, preferably at least 1.0 wt. %, more preferably in the range of 1.5 wt. % to 2.25 wt. % of the leavening mixture.

The active malt content in a leavening mixture according to the invention preferably is between 0.1 wt % and 1 wt %, more preferably between 0.1 wt % and 0.4 wt %, more preferably between 0.15% and 0.30 wt %, such as about 0.2 wt % of the leavening mixture. In a specifically preferred embodiment comprising at least 60 wt. % water, the active malt content in the leavening mixture according to the invention is advantageously in the range of 0.15-0.225 wt. % of the leavening mixture.

The (at least one) inactive yeast content in a leavening mixture according to the invention usually is at least about 0.5 wt. %, in particular at least about 1 wt. %. The (at least one) inactive yeast content in a leavening mixture according to the invention preferably is between 1.5 wt % and 2.5 wt %, more preferably between 1.75 wt % and 2.25 wt %, such as about 2 wt % of the leavening mixture. In a specifically preferred embodiment comprising at least 60 wt. % water, the inactive yeast content in the leavening mixture according to the invention is advantageously in the range of 1.5-2.25 wt % of the leavening mixture.

The (at least one) active yeast starter content, in particular the active starter Lachancea thermotolerans content, in a leavening mixture according to the invention-such as the liquid sourdough-usually is at least 0.0005 wt. %, preferably at least about 0.001 wt. %, in particular at least 0.005 wt. %, or at least 0.01 wt. %. The active starter yeast content generally is 2 wt. % or less, in particular 1 wt. % or less, more in particular 0.5 wt. % or less. Good results have also been achieved with an active starter yeast content of about 0.1 wt % or less, e.g. 0.05 wt. % or less. Advantageously, the active starter yeast content is about 50 wt. % to about 100 wt. % of the LAB starter content; amongst others, good results have been achieved wherein active starter yeast and LAB starter are used in about the same amounts by weight. In a specifically preferred embodiment, in particular an embodiment comprising 60 wt. % or more water, the active starter yeast content in the leavening mixture according to the invention is advantageously in the range of 0.0005-1 wt. % of the leavening mixture, more preferably in the range of about 0.001 to 0.5 wt. % of the leavening mixture, in particular up to 0.1 wt. % or up to 0.005 wt. %. In a further specific embodiment, in particular an embodiment wherein the leavening mixture has a water content of 60 wt. % or less, the active yeast starter content is between 0.001 wt. % and 0.05 wt. %, in particular between 0.01 wt % and 0.05 wt %, more in particular between 0.01 wt % and 0.05 wt. % or between 0.015% and 0.025 wt. %, such as about 0.02 wt. % of the leavening mixture.

The (at least one) LAB starter content in a leavening mixture, such as the liquid sourdough according to the invention—in particular the Lactobaccilus, Lactiplantibacillus or Lactobaccilus+Lactiplantibacillus starter content, more in particular the L. brevis, L. plantarum or Lactobaccilus+Lactiplantibacillus starter content, can be chosen in a wide range, usually in the range of about 0.0005 to about 5 wt. %, preferably in the range of about 0.001 to about 5 wt. %, in particular in the range of about 0.05 to about 5 wt. %, more in particular in the range of 0.1-5 wt. % or in the range of 0.2-4.8 wt. %. In a first advantageous embodiment, in particular a liquid sourdough having a water content in the range of about with 60 to about 75 wt. %, the LAB starter content is typically relatively low, typically in the range of 0.0005-3.5 wt. %, preferably in the range of about 0.001 to about 2 wt. %, in the range of 0.1-2 wt. %, or in the range of 0.1-1 wt. %. A liquid sourdough having a water content of less than 60 wt. %, may also advantageously have a lactic acid bacteria content of 0.0005-3.5 wt. %, advantageously in the range of about 0.001 wt. % to about 2 wt %, in the range of 0.1-2 wt. %, or in the range of 0.1-1 wt. %. However, also good results have been achieved with a such a liquid sourdough having a lactic acid content of more than 3.5 wt. %, such as in the range of between 4 wt % and 5 wt %, more preferably between 4.2 wt % and 4.8 wt %, more preferably between 4.4% and 4.6 wt %, such as about 4.5 wt % of the leavening mixture.

In an advantageous embodiment, the liquid sourdough according to the invention comprises a fermentable sugar, or such sugar has at least been used as an ingredient in the preparation of the sourdough. Particularly suitable are fermentable hexoses, such as fructose or glucose. In particular good results have been achieved with fructose. The fermentable sugar is a substrate for the lactic acid bacteria contributing to growth of the lactic acid bacteria and/or production of organic acid, in particular acetic acid. The presence of the fermentable sugar is in particular advantageous in an embodiment with a relatively high water content, such as of at least 60 wt. % and/or a relatively low lactic acid bacteria content when starting to prepare the liquid sourdough. It has been found to have a positive effect on yield. If added, the fermentable sugar is usually added in a concentration of up to about 5%; in particular—if present—the content of the added fermentable sugar preferably is in the range of 0.5-5 wt. %.

The mixing of the cereal flour, preferably together with other substrate components (such as malt flour, bran) for the starter organisms and/or with one or more other ingredients (such as inactive yeast, starter organisms) with water preferably is performed at or close to a fermentation temperature such as a temperature in the range of 20-50° C., preferably 25-35° C., more preferably 27-34° C., most preferably 28-32° C., in particular about 30° C. Preferably, the fermentation takes place in a fermenter under essentially full batch conditions, i.e. wherein the dough to be fermented is essentially integrally introduced into the fermenter as a single batch. Preferably, at or close to the end of the fermentation, additional yeast, in particular S. cerevisiae, is added. This yeast may also be referred to as pitch yeast. Preferably this is added in compressed, dry or cream form, more preferably in compressed or dry form, most preferably in compressed form. If added, it is usually added in a relative amount of at least 1 wt. %, based on total weight of the mixture. Preferably, it is added at a relative amount of between 3 and 7 wt. %, more preferably at a relative amount of about 5 wt. % on total weight of the mixture. The pitch yeast contributes to the viable yeast (yeast capable of reproducing) in the leavening mixture. Thus, in an advantageous embodiment, the leavening mixture has a total viable yeast content in the range of 1 to 7 wt. %, preferably 3 to 5 wt. %.

The liquid sourdough (prepared) in accordance with the invention is particularly suitable for the preparation of a sourdough-leavened bread. The preparation of the bread can be based on known baking methods. A sourdough bread can be made by making a bread dough comprising a liquid sourdough and further bread ingredients, and allowing the bread dough to leaven. The bread dough may be fermented in a fermentation cabinet, in a manner known per se, e.g. based on French legislation for the preparation of sourdough leavened bread.

Advantageously, a method for preparing a sourdough-leavened bread according to the invention, comprises mixing of the ingredients for the dough; a first fermentation of a bulk of the dough (bulk fermentation); dividing the bulk of dough in portions (weighing/rounding); allowing the portions to rest; shaping the portions; a final fermentation of the shaped portions; and baking. The bulk of the dough contains sufficient dough for the preparation of a plurality of breads. After the first fermentation, the bulk of the dough is portioned in individual portions having a suitable weight for a single bread, thereafter the individual portions are allowed to rest, thereafter the individual portions are each shaped into a bread shape (e.g. using a bread mould), thereafter the shaped doughs are subjected to a final fermentation, after which the shaped doughs are baked, thereby obtaining the bread. Conditions can be based on known methodology for the separate steps dependent on the desired bread. Bulk fermentation can for example be at a temperature of about 25° C. for about 45 minutes at about 78% moisture. The bread dough may be moulded, e.g. using a baguette moulder. After moulding the doughs may be left in a fermentation cabinet with controlled temperature and moisture, which can be based on known baking methods, for example at a temperature of about 25° C. and about 78% moisture. Baking may be performed in an oven, using baking conditions known per se, for instance at a temperature of about 240° C. e.g. for a time period of about 22 min. After the dough has been placed in an oven, vapor may be injected immediately.

For the purpose of clarity and a concise description, features are described herein as part of the same or separate aspects and preferred embodiments thereof, however, it will be appreciated that the scope of the invention may include embodiments having combinations of all or some of the features described.

The invention will now be illustrated by the following example, which is provided by way of illustration and not of limitation and it will be understood that many variations in the methods described and the amounts indicated can be made without departing from the spirit of the invention and the scope of the appended claims.

### Example 1: Role of Inactive Yeast

### Materials and Methods

All ingredients as provided in table 1 except of starters were added into a fermenter. Ingredients were not added at once. When all ingredients were mixed and the slurry was at fermentation temperature, the LAB and yeast starters were added. All ingredients were provided by AB Mauri, with exception of water.

The fermentation reaction was performed for 48 hours at 30° C. (see Table 1). Hereafter, the sourdough was cooled to 5° C. for a period of 2 hours. After the cooling step, dry or compressed yeast was added at 5% of total sourdough volume. To prevent lumps, the yeast was mixed with water in an amount equal to solids content of the yeast before addition to the fermenter.

Sourdoughs were collected and stored in jerry cans with vented lids to allow for gas exchange and prevent swelling of containers.

TABLE 1

| | Amount (g) | |
|---|---|---|
| Ingredients (source) | | |
| Wheat flour (Dossche Mills, Rotterdam, Netherlands) | 90 | |
| Wheat bran (fine milled) (Dossche Mills, Rotterdam, | 5 | |
| Netherlands) | | |
| Inactive yeast (S. cerevisiae) | 5 | |
| Active malted wheat flour (AIT ingredients, Corbeil- | 0.5 | |
| Essones, France) | | |
| Active starter yeast - L. thermotolerans (Mauri Technology, | 0.04 | |
| Etten-Leur, Netherlands) | | |
| Active starter LAB - L. brevis (Mauri Technology, Etten- | 10 | |
| Leur, Netherlands) | | |
| Water | 110 | |
| Process parameters | | |
| Fermentation time | 48 | h |
| Fermentation temperature | 30° | C. |
| Cooling time | 2 | h |
| Cooling temperature | 5° | C. |

After fermentation, sourdoughs were stored in a fridge at 5° C. for 12 weeks. Every week until week 12, samples were collected to determine TTA, pH, cell counts, organic acid content and sugar content.

For the determination of lactic acid bacteria (LAB) and yeast cell counts, 1 g of sourdough was diluted with 9 mL of Ringers solution (Sigma-Aldrich, St. Louise, MO, USA). Cell counts were determined by plating serial dilution of sourdough samples on MRS (Carl Roth, Karlsruhe, Germany) with 50 mg/L of cycloheximide (Sigma-Aldrich, St. Louise, MO, USA) and YPD agar (Sigma-Aldrich, St. Louise, MO, USA) with 30 mg/L of chloramphenicol (Sigma-Aldrich, St. Louise, MO, USA). The MRS plates were incubated anaerobically at 37° C. for 48 h and the YPD plates were incubated aerobically at 30° C. for 48 h.

For the determination of total titrable acidity (TTA) and pH, a Titroline 6000 with autosampler (SI Analytics, Mainz, Germany) was used. 5 g of sourdoughs were suspended in 100 mL of distilled water and the suspension was homogenized using Ultra Turrax T18 Digital (IKA-Werke, Staufen, Germany). The resulting aliquots were titrated with 0.1 M NaOH using Titroline 6000 titrator until the pH reached 8.5. Experiments were run in duplicate and TTA was calculated by dividing 10 by the sample weight (g), and multiplying the obtained value by the NaOH content (ml).

Organic acids and sugars were quantified by suspension of 2 g of sourdough in 20 mL of Milli-Q water. The suspension was shaken on the shaking table at 150 rpm for 30 min and thereafter centrifuged at 4000 rpm for 15 min. The supernatants were filtered directly (0.22 μm) in a HPLC vial. The samples were kept in the freezer until they were ready to use. The quantification of compounds was performed by using high performance liquid chromatography (HPLC) with Agilent Hi-Plex H (4.7×300 mm). The eluent was 0.1% TFA in Milli-Q water and the column temperature was 40° C. The injection volume of each sample was 5 L and the flow rate was 0.6 mL/min. Organic acids were detected with a VWD detector at 210 nm and sugars were detected with a refractive index (RID) detector.

### Results

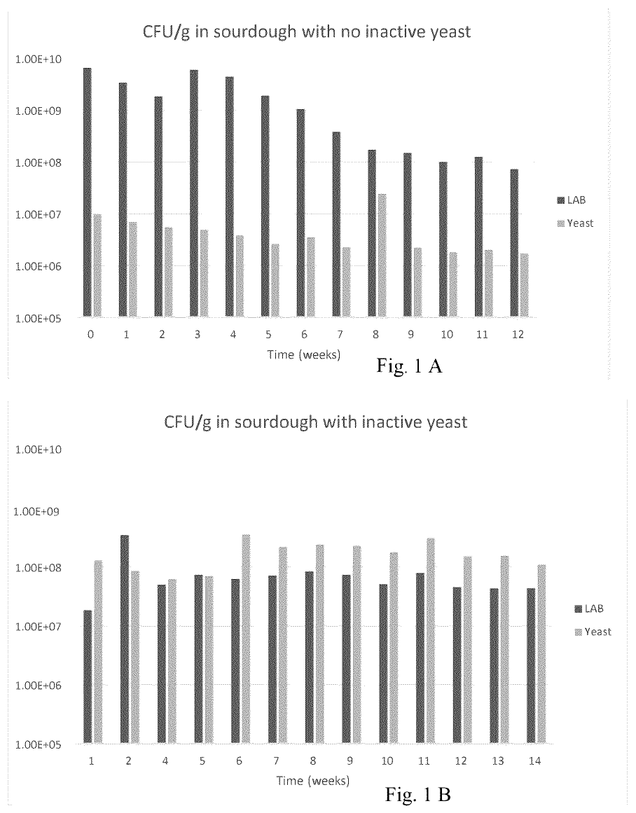

A liquid leavening mixture comprising inactive yeasts was compared to a liquid leavening mixture not comprising inactive yeasts. In the sourdough obtained by using a leavening mixture comprising inactive yeasts, there was no significant decrease in CFU/g of either bacteria or yeast observed, while this was observed in the sourdough obtained by using a leavening mixture not comprising inactive yeasts (see FIG. 1).

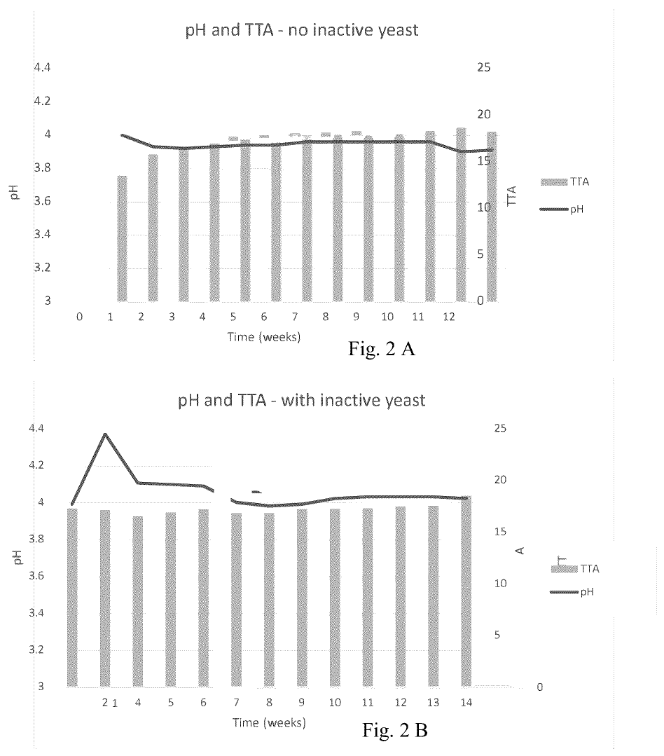

Furthermore, the total titratable acidity (TTA) of sourdough made with inactive yeast was higher and more stable throughout the shelf life of the sourdough compared to a sourdough made without inactive yeast (see FIG. 2). This allows the baker to use a lower dosage in baking to achieve the same acidity flavor notes. In sourdough with no added inactive yeast, there was a steady rise in TTA over the shelf life period, contributing to the drop in yeast and bacteria viability seen in FIG. 1A. The fact that the pH did not significantly differ between a sourdough made with or without inactive yeast may be explained by the buffering capacity of the minerals and proteins present in the bran and inactive yeasts.

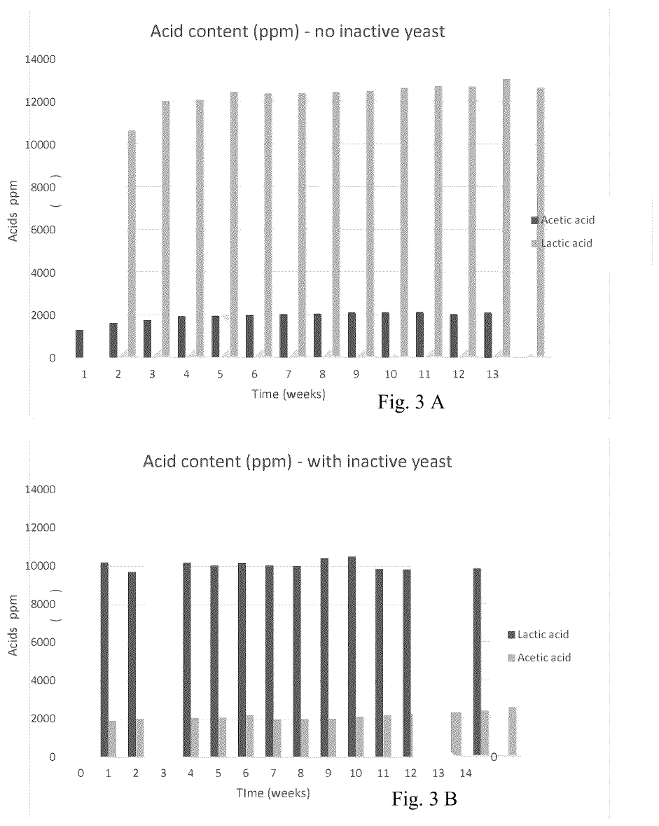

Further, the acid concentration (i.e. acetic acid and lactic acid) showed a more stable trend throughout the shelf life of the sourdough made with inactive yeast compared to a sourdough made without inactive yeast. There was a slightly higher acetic acid content and lower lactic acid content at the start of shelf-life testing, and these levels stay much the same throughout (see FIG. 3B). In the sourdough with no added inactive yeast a sharp increase in acids was observed at the start of the shelf life testing (see FIG. 3A). This would result in a product that is not consistent in quality.

### Example 2

Liquid sourdoughs were prepared in essentially the same manner as in Example 1. The ingredients were from the same source as listed as in table 1, except for the fructose. However, ingredient concentrations were varied, as indicated in table 2 below.

TABLE 2

| | | | | | Ingredients | | | | | | | | |
|---|---|---|---|---|---|---|---|---|---|---|---|---|---|
| | | | | | | | | | | | | | Sodium |
| | | Dough | | | | Inactive | Active | Fruc- | LAB | Yeast | Yeast | Xan- | diace- |
| | Date | Yield | Water | Flour | Bran | yeast | malt | tose | starter | starter | pitch | than | tate |
| | | | grams | | | | | | | | | | |
| Example 1 | Feb-22 | 200 | 110 | 90 | 5 | 5 | 0.5 | 0 | 10 | 0.001 | 5 | 0 | 0 |
| | | | % of total sourdough volume | | | | | | | | | | |
| LactosanBrevis_001 | 2024 | 285 | 65 | 27.825 | 1.75 | 0 | 0.175 | 0 | 0.001 | 0.001 | 0 | 0.8 | 0 |
| | Jan. 31 | | | | | | | | | | | | |
| F20_001 | 2024 | 285 | 65 | 31.5 | 1.75 | 1.75 | 0 | 0 | 3.5 | 0.001 | 5 - dry | 0.8 | 0.6 |
| | Feb. 26 | | | | | | | | | | and | | |
| | | | | | | | | | | | fresh | | |
| F20_002 | 2024 | 285 | 65 | 34.825 | 1.75 | 0 | 0 | 0 | 3.5 | 0.001 | 5 | 0.8 | 0.6 |
| | Mar. 4 | | | | | | | | | | | | |
| Acetic_001 | 2024 | 285 | 65 | 33.075 | 1.75 | 0 | 0.175 | 3 | 0.001 | 0.001 | 5 | 0.8 | 0.6 |
| | Apr. 4 | | | | | | | | | | | | |
| Acetic_002 | 2024 | 285 | 65 | 34.825 | 1.75 | 0 | 0 | 3 | 0.001 | 0.001 | 5 | 0.8 | 0.6 |
| | Apr. 8 | | | | | | | | | | | | |

These liquid sourdoughs (with the exception of the ‘Example 1’ sourdough) are reference examples in that they lack at least one ingredient. Properties of these liquid sourdoughs, such as stability of the living yeast and lactic acid bacteria, TTA, acid concentration (lactic acid and acetic acid) are compared with a corresponding liquid sourdough according to the invention.

1. A leavening mixture, which leavening mixture is a liquid sourdough, comprising: cereal flour, preferably wheat flour, active malt flour, at least one inactive yeast, at least one active lactic acid producing starter bacterium, at least one active starter yeast and water.

2. A leavening mixture according to claim 1, wherein the liquid sourdough has a pH at 20° C. in the range of 3.5 to 4.6.

3. The leavening mixture according to claim 1, wherein the at least one inactive yeast is Saccharomyces cerevisiae and the at least one lactic acid producing bacterium is selected from the genera Lactobaccilus and Lactiplantibacillus.

4. The leavening mixture according to claim 1, wherein the at least one lactic acid producing bacterium is selected from the species L. brevis and L. plantarum.

5. The leavening mixture according to claim 1, wherein at least one active yeast is Lachancea thermotolerans.

6. The leavening mixture according to claim 1, wherein at least one active yeast is S. cerevisiae.

7. The leavening mixture according to claim 1, wherein the acetic acid content is in the range of 1200 to 3200 mg per kilogram of the leavening mixture.

8. The leavening mixture according to claim 1, wherein the lactic acid content ranges from 6000 to 20000 mg per kilogram of the leavening mixture.

9. The leavening mixture according to claim 1, wherein the composition comprises at least about 10 million active yeast cells per gram and at least about 1 billion active lactic acid bacteria per gram of mixture.

10. The leavening mixture according to claim 1, wherein the composition further comprises a wheat bran.

11. The leavening mixture according to claim 1, having a flour content in the range of 20-45 wt. %.

12. The leavening mixture according to claim 10, wherein the having a wheat bran content in the range of 0.5-3 wt. %.

13. The leavening mixture according to claim 1, having an active malt flour content is in the range of 0.1-1 wt. %.

14. The leavening mixture according to claim 1, having an inactive yeast content of at least 1 wt. %.

15. The leavening mixture according to claim 1, having an active yeast starter content of at least 0.005 wt. %.

16. The leavening mixture according to claim 1, having a lactic acid producing starter bacteria content is in the range of 0.005-5 wt. %.

17. The leavening mixture according to claim 1, having a water content in the range of 60-75 wt. % and a cereal flour content of 20-37 wt. %.

18. (canceled)

19. The leavening mixture according to claim 17, having a lactic acid bacteria content in the range of 0.001-2 wt. %.

20. The leavening mixture according to claim 1, having a water content in the range of 40-60 wt. %, and a cereal flour content in the range of 37-45 wt. %.

21. (canceled)

22. The leavening mixture according claim 20, having a lactic acid bacteria content in the range of 0.001-1 wt. %, in the range of 1-4 wt. % or in the range of 4-5 wt. %.

23. The leavening mixture according to claim 1, having a water content in the range of 40-60 wt. % or in the range of 60-75 wt. %; an active malt flour content in the range of 0.1-1 wt. %; an inactive yeast content in the range of 1-2.5 wt. % and an active yeast starter content of 0.01-0.05 wt. %.

24. The leavening mixture according to claim 1, having a water content in the range of 60-75 wt. %; an active malt flour content in the range of 0.1-1 wt. %; an inactive yeast content in the range of 1-2.5 wt. % an active yeast starter content of 0.001-1 wt. %. and an lactic acid bacteria content of 0.001-1 wt. %.

25. The leavening mixture according to claim 1, having a total viable yeast content in the range of 1 to 7 wt. %.

26. The leavening mixture according to claim 1, further comprising fructose, wherein the fructose content, is in the range of 0.5-5 wt. %.

27. A fermentable dough, comprising: cereal flour, preferably wheat flour, active malt flour, at least one inactive yeast, at least one active lactic acid producing starter bacterium, at least one active starter yeast and water.

28. (canceled)

29. Method for preparing a liquid leavening mixture, which leavening mixture is a liquid sourdough according to claim 1, comprising:
i) preparing a dough comprising cereal flour, active malt flour, at least one inactive yeast, at least one active lactic acid producing starter bacterium, at least one active starter yeast, water, to obtain the dough,
ii) subjecting the dough to fermentation, thereby forming a liquid sourdough;
iii) cooling the fermented mixture to a temperature of less than 10° C.

30. Method according to claim 29, wherein the dough is subjected to fermentation for 15-48 hours; at a temperature in the range of 25-35° C.

31. Method according to claim 29, wherein the fermentation takes place in a fermenter under essentially full batch conditions, i.e. wherein the dough to be fermented is essentially integrally introduced into the fermenter as a single batch.

32. Method according to claim 29, further comprising the step of: adding S. cerevisiae in compressed, dry or cream form to the liquid sourdough.

33. Method for preparing a sourdough-leavened bread, comprising the steps of:
providing a liquid sourdough according to claim 1;
making a bread dough comprising the liquid sourdough and further bread ingredients;
allowing the bread dough to leaven and
baking the bread dough, thereby forming the sourdough-leavened bread.

34. Method for preparing a sourdough-leavened bread according to claim 33, wherein making the bread dough comprises mixing of the liquid sourdough and further bread ingredients under formation of a bulk of bread dough, wherein thereafter the bulk of the bread dough is subjected a first fermentation, thereafter the bulk of the dough is portioned into individual portions having a suitable weight for a single bread, thereafter the individual portions are allowed to rest, thereafter the individual portions are each shaped into a bread shape, thereafter the shaped doughs are subjected to a final fermentation, after which the shaped doughs are baked, thereby obtaining the sourdough-leavened bread.

35. Sourdough-leavened bread, obtained by a method according to claim 33.

36. Sourdough-leavened bread according to claim 35, having a pH of 4.3 or less and an acetic acid concentration of at least 900 ppm.

37. A fermentable dough according to claim 27 having a pH at 20° C. in the range of 5 5.8-6.5.
